(19) United States
(12) Patent Application Publication
(10) Pub. No.: US 2012/0263513 A1
(43) Pub. Date: Oct. 18, 2012

(54) VIEWING DISPLAY IMAGERY THROUGH A KEYBOARD KEYCAP

(75) Inventor: Glen C. Larsen, Issaquah, WA (US)

(73) Assignee: MICROSOFT CORPORATION, Redmond, WA (US)

(21) Appl. No.: 13/087,942

(22) Filed: Apr. 15, 2011

(51) Int. Cl. B41J 5/00

(52) U.S. Cl. 400/490

(57) ABSTRACT

A computer peripheral is provided in which depressible keys are situated over a display device. A region on the display device is associated with each key. Each key includes a keycap with a central viewing window for viewing changeable display imagery produced by the display region associated with the key. Each key has a mechanical understructure that guides and constrains movement of the keycap toward and away from the display device. The mechanical understructure is configured to not optically obstruct through-keycap viewing of changeable display imagery produced on the associated region of the display. In many examples, the mechanical understructure is positioned outside of the display region to provide such unobstructed viewing.

### BACKGROUND

Computer peripherals are continually being refined to expand functionality and provide quality user experiences. One area of improvement has been to provide peripheral devices that combine keyboard-type input functionality with the ability to display output to the user. In many cases, this is implemented by providing a keyboard with a display region that is separate from the keys. For example, in a conventional keyboard layout, a rectangular liquid crystal display (LCD) can be situated above the function keys or number pad.

Another approach to combining input and output capability in a peripheral device is the use of a virtual keyboard on a touch interactive display. In this case, the display capability is provided directly on the keys: each key typically is displayed by the touch interactive device with a legend or symbol that indicates its function. The virtual keyboard approach has many benefits, including the ability to dynamically change the display for each key. Interactive touch displays are often less desirable, however, from a pure input standpoint. Specifically, touch displays do not provide tactile feedback, which can provide a more responsive and agreeable typing experience.

### SUMMARY

This disclosure provides a computer peripheral in which mechanically-depressible keys are situated over a display device. Each key includes a keycap movably coupled to the display device via a mechanical understructure which guides movement of the keycap toward and away from the display device. A central viewing window of the keycap is aligned with a region on the display associated with the keycap. The mechanical understructure is configured to not optically obstruct through-keycap viewing of changeable display imagery produced on the associated region of the display. In many examples, the mechanical understructure is positioned outside of the central display region on each key to provide such unobstructed viewing.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 depicts an exemplary computing system including a computer peripheral that provides displayable output which is viewable through physically/mechanically-depressible keys situated over a display device.

FIG. 2 is an exploded view of the computer peripheral of FIG. 1.

FIG. 3 illustrates an example of the output display capability that may be employed in connection with the computer peripheral of FIGS. 1 and 2.

FIG. 4 shows an example spatial relationship for a keycap's mechanical understructure and the display region associated with the keycap. In particular, the figure shows the mechanical understructure being outside of the display region associated with the keycap.

FIG. 5 depicts an example of a mechanical understructure that may be employed with the keycaps shown in FIGS. 1-3.

FIG. 6 depicts an example force-displacement response that arises in connection with certain mechanical understructure configurations.

FIGS. 7-9 depict aspects of a base structure that may be employed in connection with the computer peripheral and keycaps shown in FIGS. 1-3.

FIGS. 10-15 depict further examples of mechanical understructures that may be employed with the keycaps shown in FIGS. 1-3.

### DETAILED DESCRIPTION

This disclosure will now be discussed in detail with reference to various figures. It will be appreciated that some figures contain common features and are therefore described with common reference numbers consistently throughout this disclosure. To avoid redundancy, such features will not be discussed repeatedly. Further, it will be appreciated that the figures are provided by way of example and are not meant to be limiting in any way. Some features of the figures may not necessarily be drawn to scale, and as such, some features may be exaggerated or simplified for illustrative purposes. This is for simplicity of understanding and not for technical accuracy.

This disclosure provides for a computer peripheral in which a display device provides dynamic and changeable display imagery that can be viewed through mechanically-depressible keys that are situated over the display device. In many embodiments, each key has a keycap which is movably coupled relative to the underlying display device by a mechanical understructure. The mechanical understructure guides reciprocating movement of the keycap toward and away from the underlying display device, and can also provide a force response when the keycap is depressed. The force response causes the keycap to return to an un-depressed state once released by the user. In some cases the force-displacement response is non-linear to provide desired tactile feedback when the user presses the key.

The keycaps herein typically have a central viewing window that is aligned with a display region on the display device that is associated with the key. The central viewing window is transparent to permit through-keycap viewing of imagery produced by the associated display region. To optimize viewing, the mechanical understructures and other components of the peripheral are configured to not optically obstruct through-keycap viewing. Accordingly, in many embodiments, the mechanical understructure is positioned peripherally outside of the display region associated with the key. For example, the mechanical understructure can surround but not intrude into the display region, or can be positioned to the side of the display region. Many configurations are possible to provide mechanical movement without obstructing display imagery.

The examples herein provide a combination of benefits which is not present in conventional computer peripherals. The mechanical key movement in conventional keyboards provides good tactile feel when typing, but the indicia on the keys is static (i.e., the QWERTY labels on a conventional English keyboard do not change). On the other hand, virtual keyboards, such as those on touch interactive displays, provide the benefit of dynamic display imagery but they lack the feel provided by a mechanical keyboard. The discussion to follow provides numerous examples of computer peripherals that provide dynamic display imagery and good mechanical feel when typing.

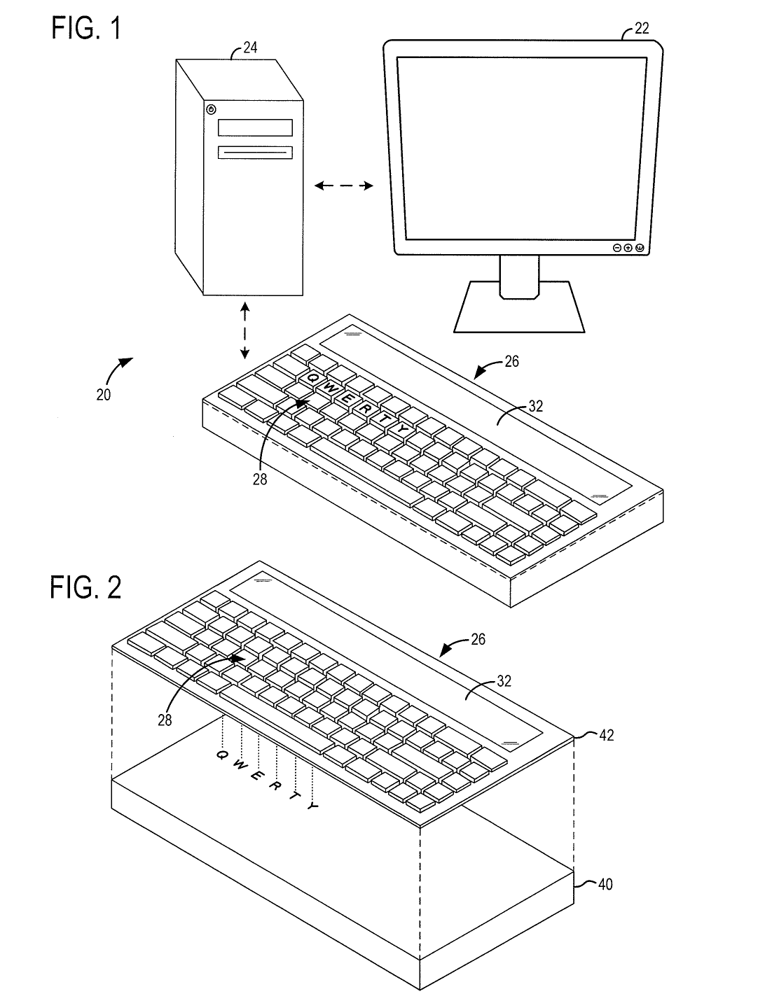

Turning now to the figures, FIG. 1 depicts an exemplary computing system 20 comprising a display monitor 22, a component enclosure 24 (e.g., containing a processor, memory, hard drive, etc.), and a computer peripheral 26 shown in a non-exploded state. FIG. 2 provides an additional view of computer peripheral 26 (exploded) and exemplary components that may be used in its construction. As will be described in various examples, computer peripheral 26 may be implemented to provide displayable output in addition to keyboard-type input functionality.

In some examples, displayable output of the computer peripheral is provided from a liquid crystal display (LCD) or other display device, and is viewed through the plurality of keys of a keyboard assembly that is disposed over the top of the display device. Individual keys may be implemented via a keycap and a mechanical understructure that guides reciprocating movement of the keycap toward and away from the underlying display device.

The terms “input” and “output” will be used in this description in reference to the keyboard functionality of the exemplary computer peripherals. When used in connection with a keyboard key, the term “input” will generally refer to the input signal that is provided by the peripheral upon activation of the key. “Output” will generally refer to the display provided for a key, such as the displayed legend, icon or symbol that indicates the function of the key.

As indicated by the “Q”, “W”, “E”, “R”, “T”, “Y”, etc., on keys 28 (FIGS. 1 and 2), it will often be desirable that computer peripheral 26 be configured to provide conventional alphanumeric input capability. To simplify the illustration, many keys of FIGS. 1 and 2 are shown without indicia, though it will be appreciated that a label or display will often be included for each key. Furthermore, in addition to or instead of the well-known “QWERTY” formulation, the keys 28 of the keyboard may be variously configured to provide other inputs. Keys may be assigned, for example, to provide functionality for various languages and alphabets, and/or to activate other input commands for controlling computing system 20. In some implementations, the key functions may change dynamically, for example in response to the changing operational context of a software application running on computing system 20. For example, upon pressing of an “ALT” key, the key that otherwise is used to enter the letter “F” might instead result in activation of a “File” menu in a software application. Generally, it should be understood that the keys in the present examples may be selectively depressed to produce any type of input signal for controlling a computer.

Computer peripheral 26 can provide a wide variety of displayable output. In some examples, the computer peripheral causes a display of viewable output on or near the individual keys 28 to indicate key function. This can be seen in FIGS. 1 and 2, where instead of keys with letters painted, printed or etched onto the keycap surface, a display mechanism (e.g., a liquid crystal display (LCD) device situated under the keys) is used to indicate the “Q”, “W”, etc., functions of the keys. This dynamic and programmable display capability facilitates potential use of the computer peripheral 26 in a variety of different ways. For example, the English-based keyboard described above could be alternately mapped to provide letters in alphabetical order instead of the conventional “QWERTY” formulation, and the display for each key could then be easily changed to reflect the different key assignments.

The display capability contemplated herein may be used to provide any type of viewable output to the user of computing system 20, and is not limited to alphabets, letters, numbers, symbols, etc. As an alternative to the above examples, images may be displayed in a manner that is not necessarily associated in a spatial sense with an individual key. An image might be presented, for example, in a region of the keyboard that spans multiple keys. The imagery provided need not be associated with the input functionality of the keyboard. Images might be provided, for example, for aesthetic purposes, to personalize the user experience, or to provide other types of output. Indeed, the present disclosure encompasses display output for any purpose. Also, in addition to display provided on or near keys 28, display functionality may be provided in other areas, for example in an area 32 located above keys 28. Still further, area 32 or other portions of computer peripheral 26 may be provided with touch or gesture-based interactivity in addition to the keyboard-type input provided by keys 28. For example, area 32 may be implemented as an interactive touchscreen display, via capacitance-based technology, resistive-based technology or other suitable methods.

Turning now to FIG. 2, computer peripheral 26 may include a display device 40 and a keyboard assembly 42 disposed over and coupled with the display device. Keyboard assembly 42 may be at least partially transparent, and may be otherwise configured to allow a user to view images produced by the display device through the keyboard assembly. In particular, each keycap has a central viewing window that is aligned with an associated display region on the display device. For example, the “Q” display in FIGS. 1 and 2 is provided on a display region of the display device that is aligned with a central viewing window of the overlying keycap. Accordingly, a user can see the “Q” symbol produced by the display device by looking through the central viewing window of the keycap at the associated display region.

As indicated briefly above, one type of suitable display device is an LCD device. This is non-limiting, however, and it should be appreciated that the keyboard assembly may be coupled with a variety of other display types.

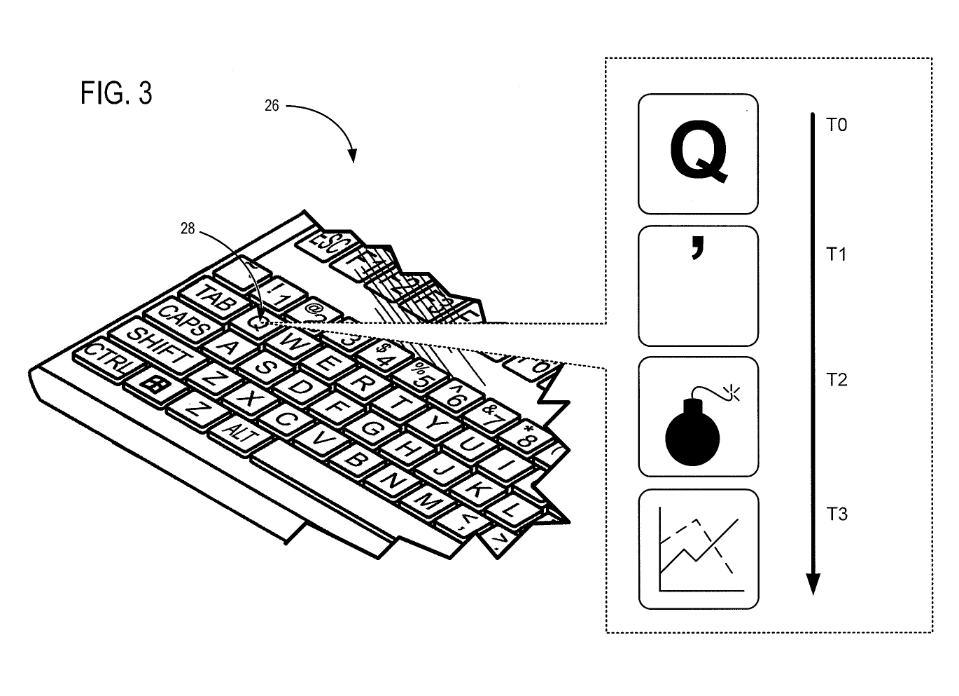

FIG. 3 provides further illustration of how the display capability of computer peripheral 26 may be employed in connection with an individual key 28. In particular, as shown respectively at times T0, T1, T2, etc., the display output associated with key 28 may be changed, for example to reflect the input command produced by depressing the key. However, as previously mentioned, the viewable output provided by the computer peripheral may take forms other than displays associated with individual keys and their input functionality.

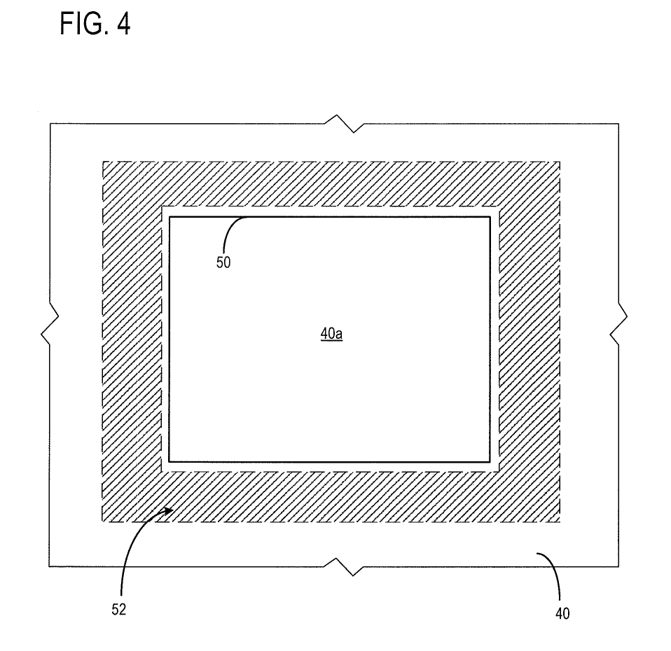

FIG. 4 illustrates an example spatial relationship between a keycap's mechanical understructure and the display region associated with the keycap. In the figure, boundary 50 corresponds to a central viewing window of a keycap, and is aligned with a display region 40a that is associated with the keycap. The hashed region 52 indicates an area outside of display region 40a in which the mechanical understructure of the keycap may be located. When disposed in region 52, the mechanical understructure will not optically obstruct changeable display imagery produced by/at display region 40a.

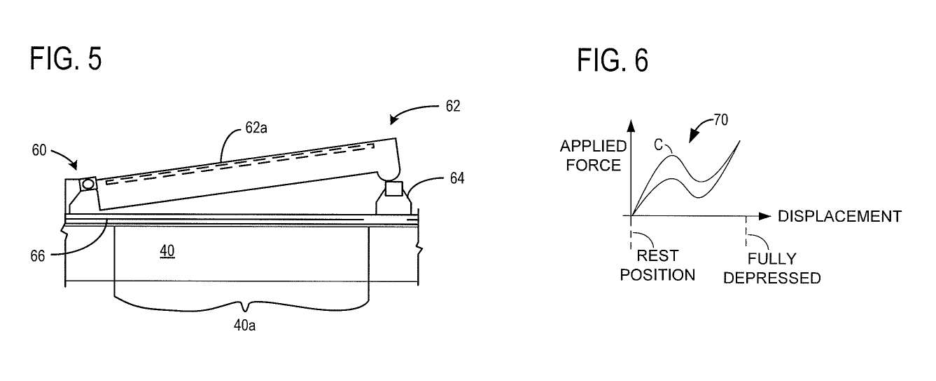

FIG. 5 illustrates a first example of a mechanical understructure. In this example, the mechanical understructure includes a hinge 60 that movably couples keycap 62 relative to display device 40. Central viewing window 62a of keycap 62 is aligned with display region 40a of display device 40. The hinge guides reciprocating movement of the keycap toward and away from the display device.

The mechanical understructure in FIG. 5 also includes a resiliently-deformable dome structure 64. Hinge 60 and dome structure 64 are positioned outside of the display region associated with the keycap, e.g., within region 52 of FIG. 4. More particularly, hinge 60 is disposed to one side of the display region, with dome structure 64 located at an opposing side of the display region. The positioning of these structures is such that they do no optically obstruct the display region.

Continuing with resiliently-deformable dome structure 64, depression of keycap 62 causes it to collapse or otherwise resiliently deform. As the keycap is depressed by the user, structure 64 provides a force response, e.g., a force as a function of keycap displacement relative to the display device. The mechanical understructure may be configured to provide various force response characteristics, for example to provide a desired tactile feel/response when the key is depressed by the user. Regardless of its particular characteristics, the force response in this and other examples causes the keycap to return to its un-depressed state when released by the user.

FIG. 6 shows an illustration of the force-displacement response that may be provided by structure 64 of FIG. 5. As keycap 62 moves toward display device 40, structure 64 collapses as the key approaches its fully depressed position. Upon release of the key, structure 64 bounces back and urges the keycap back into its un-depressed position. FIG. 6 shows the tactile response in the form of a non-linear force-displacement characteristic 70. The upper portion of the characteristic corresponds to the key being depressed; the lower corresponds to release of the key. As seen in the characteristic, as the key is displaced from a rest position toward being fully depressed, a relatively higher amount of force is needed to move the key through the initial part of its range. At some point, structure 64 collapses, as indicated by the corner C in the characteristic. This collapse is tangibly felt by the user, and provides affirming feedback that the key has been actuated. Although this is described in connection with FIG. 5, similar structures and force responses may be employed in connection with the various other mechanical understructure examples discussed herein.

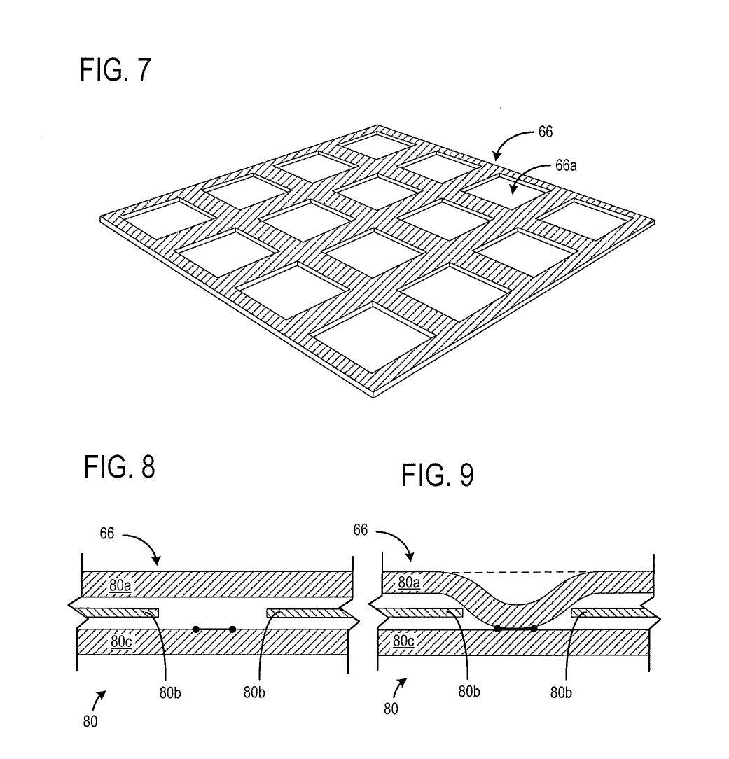

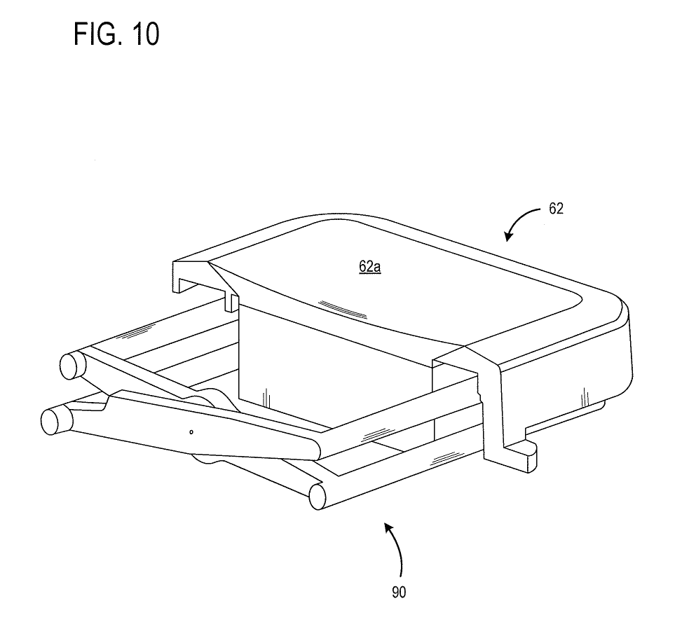

In the example of FIG. 5, the mechanical understructure movably couples the keycap 62 to a base structure 66 disposed over the display device. FIGS. 7 and 9 illustrate features that may be employed in connection with base structure 66 and base structures that may be used in connection with the other examples of this disclosure.

FIG. 7 illustrates an example of how a base structure is configured to not interfere with display output of an underlying display device. In particular, base structure 66 includes a plurality of holes 66a. Each of the holes may be aligned with the central viewing window of a keycap and the associated region on the display device. In such a configuration, the base structure does not optically obstruct the changeable display imagery produced at each display region. In other examples, the base structure does not have holes but is instead formed from a transparent material.

FIGS. 8 and 9 show an electrical trace network 80 that may be incorporated as part of base structure 66. Electrical trace network includes an upper conductive layer 80a and a lower conductive layer 80c, separated by an insulating layer 80b. When a keycap is depressed, upper layer 80a is resiliently deformed so that it is brought into electrical contact with lower layer 80c through a hole in the insulating layer 80b (FIG. 9). As a result, an input signal associated with the overlying keycap is generated, for use in controlling an attached computing device. For example, depressing a “Q” keycap would cause insertion of this character into a word processing program being executed on the computing device.

As an alternative to the electrical trace network of FIGS. 8 and 9, inputs may be generated by other methods. For example, a portion of the keycap or mechanical understructure could press down onto a touch sensitive layer, e.g., a touch interactive display device. Other examples can employ optical detection of key presses. Virtually any type of technology may be employed to detect pressing of the mechanical keys to produce input signals associated with the keys.

FIG. 10 provides another example of a mechanical understructure in the form of a scissors assembly 90 that movably couples keycap 62 relative to an underlying display device (not shown in FIG. 10). Scissors assembly 90 guides and constrains reciprocating movement of the keycap toward and away from a display region on the display device that is associated with the keycap. As in the other examples, keycap 62 includes a central viewing window 62a that is aligned with the underlying display region, to permit through-keycap viewing of changeable display imagery.

As shown in FIG. 10, scissors assembly 90 extends around a central portion of keycap. More particularly, the scissors assembly may be located within region 52 of FIG. 4, so as to not optically obstruct the display region aligned with the central viewing window. The mechanical understructure of FIG. 10 may also include further components to provide a desired force-displacement response and to return the keycap to an un-depressed position after being released by the user. The force-displacement response components may include springs, collapsible domes or any other resiliently-deformable structure.

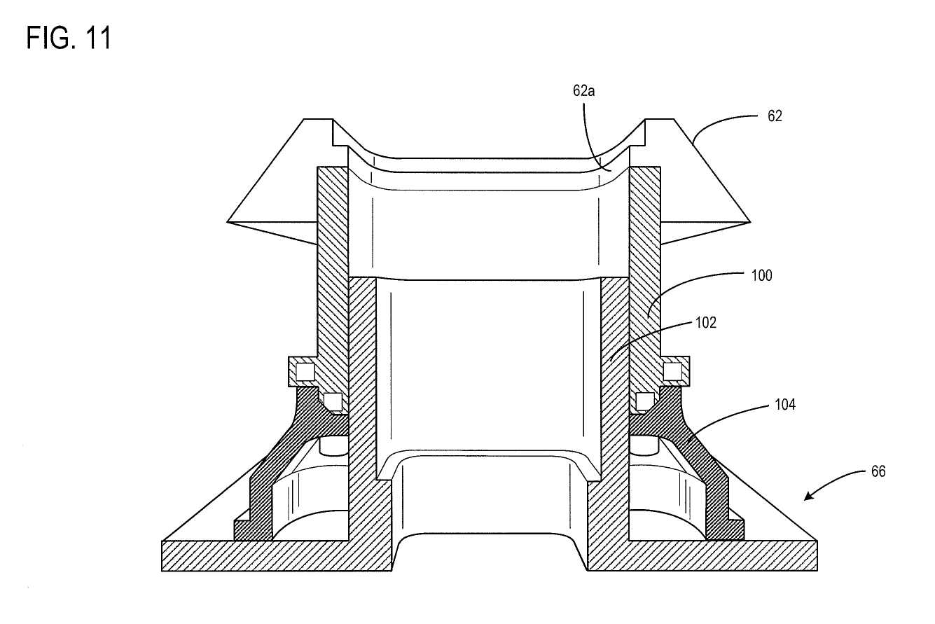

FIG. 11 provides yet another example of a mechanical understructure. In the figure, as in other examples, keycap 62 has a central viewing window 62a aligned with an associated display region on the underlying display device. A portion 100 extends downward from the keycap and telescopically engages with a portion 102 that extends upward from a base structure 66 that is situated over the display device. A resiliently-deformable collapsible structure 104 is coupled between telescoping portion 100 and base structure 66. When the key is depressed, structure 104 collapses to provide a force response similar to that shown in FIG. 6. Once the key is released, structure 104 causes the key to return to its un-depressed state.

Structures 100, 102 and 104 are all positioned outside of the display region associated with keycap 62, as in the spatial configuration described in FIG. 4. Accordingly, the mechanical understructure does not optically obstruct through-keycap viewing of display imagery provide by the display region.

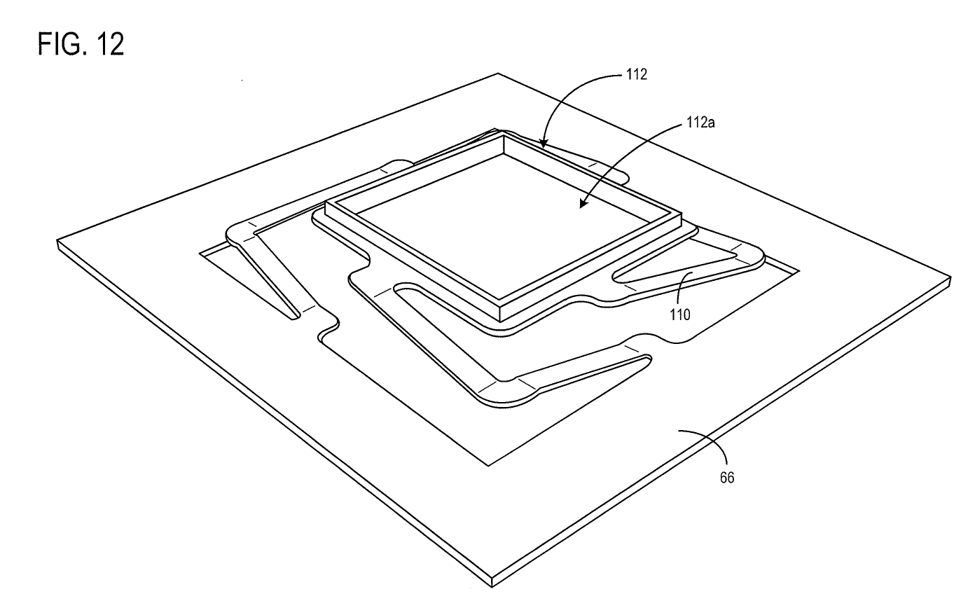

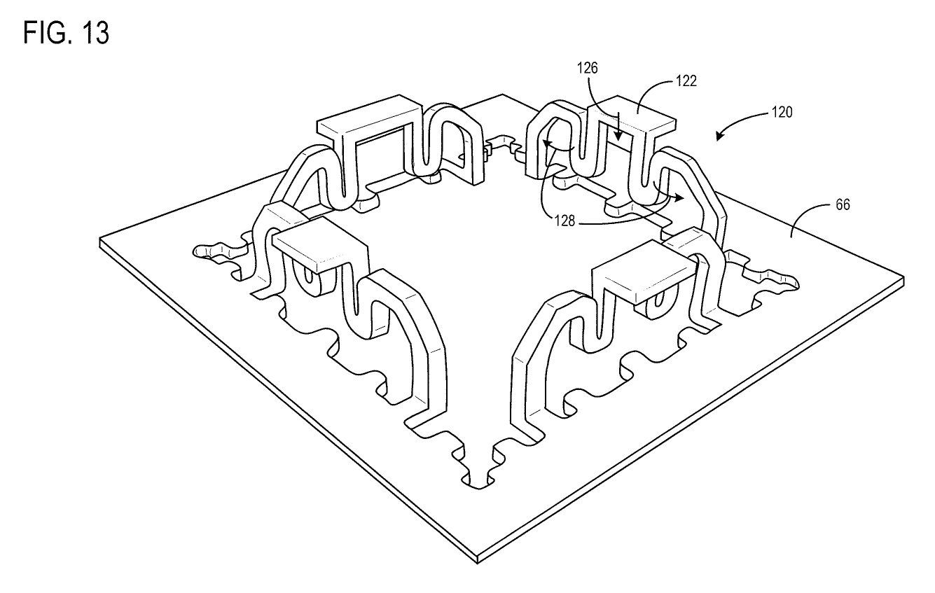

FIGS. 12-14 provide examples in which the mechanical understructure includes spring structure that provides a force response and which guides and constrains movement of the keycap toward and away from the underlying display device.

In FIG. 12, the spring structure includes cantilevered springs 110 that resiliently deform in response to depression of the supported keycap. Cantilevered springs 110 extend between keycap support 112 and base structure 66, which is positioned over the surface of an underlying display device. Keycap support 112 defines a central opening 112a which is aligned with the viewing window of the supported keycap and the associated region of the underlying display device. The cantilevered springs and other portions of the depicted mechanical understructure are positioned outside the display region, as in the spatial relationship described in FIG. 4. Accordingly, the mechanical understructure in this example does not optically obstruct through-keycap viewing of the changeable display imagery provided by the display region associated with the keycap.

In FIG. 13, the spring structure includes torsional spring structures 120 positioned on four sides, for example, of a supported keycap. However it will be appreciated that other number(s) of spring structures are also possible. Each torsional spring structure 120 extends between a keycap support and base structure 66, which is positioned over the underlying display device. As the keycap is depressed (indicated by arrow 126), portions of the torsional spring structure 120 rotate torsionally, as indicated by arrows 128.

As in the other examples, torsional spring structures 120 guide and constrain keycap movement. The spring structures provide a force-displacement response that gives the key a certain feel when depressed, and that returns the keycap to an un-depressed state upon release. Furthermore, the torsional spring structures are positioned outside of the central viewing window of the keycap and the associated display region on the underlying display device. Accordingly, the torsional spring structures permit unobstructed through-keycap viewing of the changeably display imagery for the key.

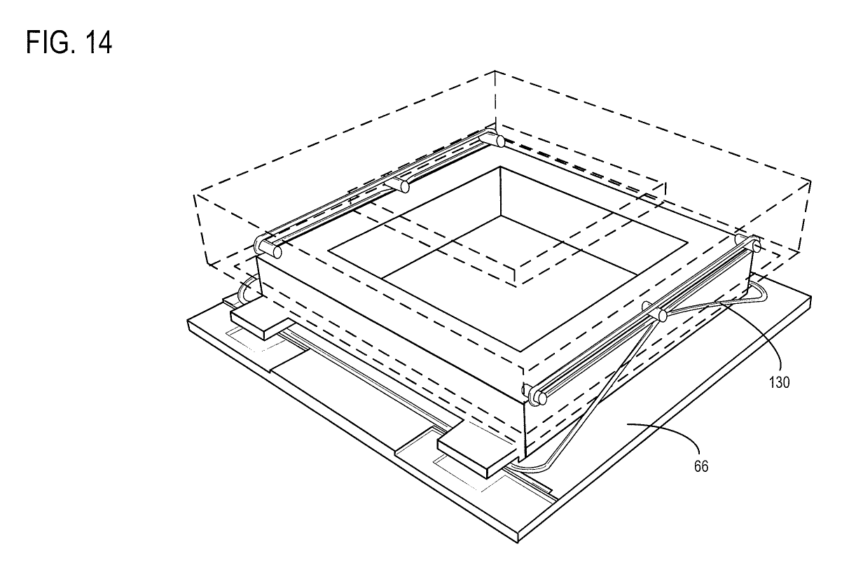

FIG. 14 provides still another example of a spring-type mechanical understructure. In this example, a wire spring structure 130 extends between the supported keycap and base structure 66. Wire spring 130 guides and constrains movement of the keycap toward and away from the underlying display device. The wire spring also has a force-displacement response that provides the key with a certain feel and returns the keycap to an un-depressed state upon release. The figure also shows that the wire spring structure is positioned at a periphery of the key, so that it is outside the display region as in the example spatial relationship of FIG. 4. Accordingly, the wire spring permits unobstructed through-keycap viewing of the changeable display imagery.

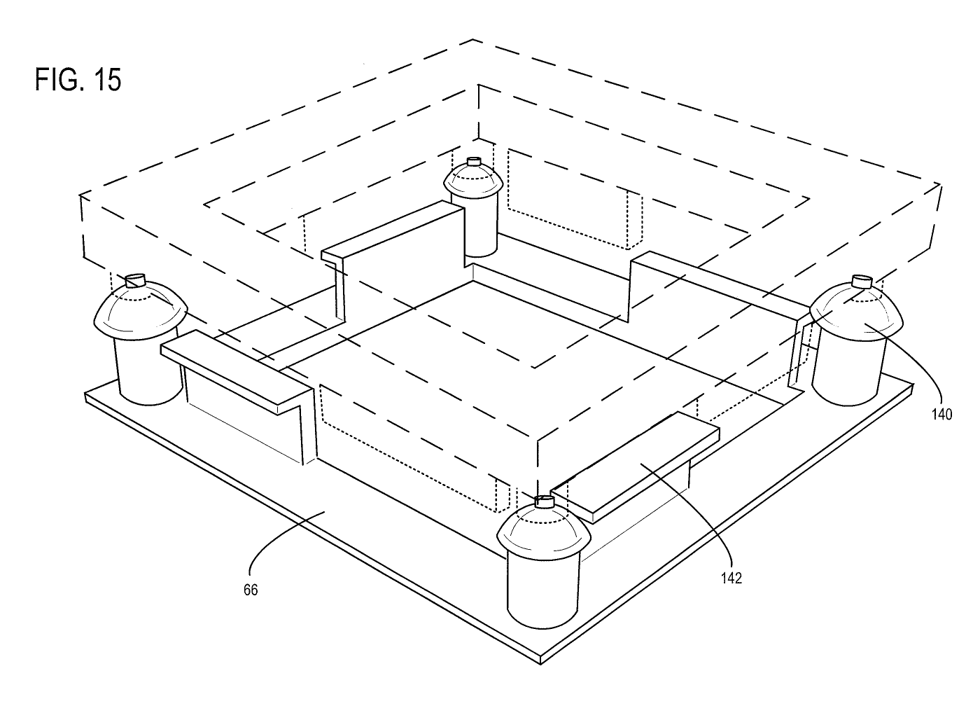

FIG. 15 provides yet another example of a mechanical understructure. In this example, the mechanical understructure includes four collapsible dome structures 140 supporting the keycap. However, it will be appreciated that other number(s) of domes are also possible. Each of the dome structures may be similar to the collapsible dome of FIG. 5. The mechanical understructure may also include tabs 142 extending upward from base structure 66, to further assist in guiding and constraining keycap movement. As should be appreciated from the figure, the mechanical understructure components are in the general spatial configuration of FIG. 4, in which they permit unobstructed through-keycap viewing of images from the display device.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computer peripheral, comprising:
a display device; and
a keyboard assembly disposed over the display device and including a plurality of depressible keys, each of the plurality of depressible keys having a keycap and a mechanical understructure coupled between the keycap and display device, wherein the mechanical understructure:
is disposed outside of a display region on the display device that is associated and aligned with a central viewing window of the keycap, so as to not optically obstruct through-keycap viewing of changeable display imagery produced by the display region;
is configured to guide reciprocating movement of the keycap toward and away from the display device; and
is configured to provide a force response in connection with depression of the keycap toward the display device, said force response causing the keycap to return to an un-depressed position upon release.

2. The computer peripheral of claim 1, wherein the mechanical understructure includes spring structure to provide said force response.

3. The computer peripheral of claim 2, wherein the spring structure includes a plurality of cantilevered springs coupled between the keycap and the display device.

4. The computer peripheral of claim 2, wherein the spring structure includes a wire spring assembly coupled between the keycap and the display device.

5. The computer peripheral of claim 2, wherein the spring structure includes one or more torsional springs coupled between the keycap and the display device.

6. The computer peripheral of claim 1, wherein the mechanical understructure includes a resiliently-deformable dome structure to provide the force-displacement response, the resiliently-deformable dome structure being configured so that the force-displacement response is non-linear.

7. The computer peripheral of claim 6, wherein the resiliently-deformable dome structure is one of a plurality of such resiliently-deformable dome structures included in the mechanical understructure.

8. The computer peripheral of claim 6, wherein the mechanical understructure includes a scissors assembly.

9. The computer peripheral of claim 1, wherein the mechanical understructure includes a first portion connected to the keycap that is telescopically engaged with a second portion connected to the display device, the mechanical understructure further including a resiliently-deformable structure coupled between the first portion and the second portion to provide the force-displacement response, the resiliently-deformable structure being configured so that the force-displacement response is non-linear.

10. The computer peripheral of claim 1, wherein the mechanical understructure includes a hinge that movably couples the keycap to the display device.

11. The computer peripheral of claim 1, further comprising an electrical trace network which, for each of the plurality of keys, is operative in response to keycap depression to produce an input signal associated with the key for controlling a computing device.

12. The computer peripheral of claim 1, wherein the display device is touch sensitive and operative, for each of the plurality of keys, to produce an input signal associated with the key for controlling a computing device.

13. A computer peripheral, comprising:
a display device; and
a keyboard assembly disposed over the display device and including a plurality of depressible keys, each of the plurality of depressible keys having a keycap and a mechanical understructure coupled between the keycap and display device to guide reciprocating movement of the keycap toward and away from the display device, the mechanical understructure being configured to not optically obstruct viewing, through a central viewing window of the keycap, of changeable display imagery produced by the display device.

14. The computer peripheral of claim 13, wherein the mechanical understructure includes spring structure to provide a force response in connection with depression of the keycap toward the display device, the force response causing the keycap to return to an un-depressed position upon release.

15. The computer peripheral of claim 14, wherein the spring structure includes a plurality of cantilevered springs coupled between the keycap and the display device.

16. The computer peripheral of claim 14, wherein the spring structure includes a wire spring assembly coupled between the keycap and the display device.

17. The computer peripheral of claim 14, wherein the spring structure includes one or more torsional springs coupled between the keycap and the display device.

18. A computer peripheral, comprising:
a display device; and
a keyboard assembly disposed over the display device and including a plurality of depressible keys, each of the plurality of depressible keys having a keycap and a mechanical understructure coupled between the keycap and display device, wherein the mechanical understructure: (a) is disposed outside of a display region on the display device that is associated and aligned with a central viewing window of the keycap, so as to not optically obstruct through-keycap viewing of changeable display imagery produced by the display region, (b) is configured to guide reciprocating movement of the keycap toward and away from the display device, and (c) includes a resiliently-deformable dome structure that provides a non-linear force-displacement response in connection with depression of the keycap toward the display device, the force-displacement response causing the keycap to return to an un-depressed position upon release; and
an electrical trace network which, for each of the plurality of keys, is operative in response to keycap depression to produce an input signal associated with the key for controlling a computing device.

19. The computer peripheral of claim 18, wherein the mechanical understructure includes a hinge that movably couples the keycap to the display device.

20. The computer peripheral of claim 18, wherein the mechanical understructure includes a scissors assembly that movably couples the keycap to the display device.
